(19) United States
(12) Patent Application Publication
(10) Pub. No.: US 2012/0101894 A1
(43) Pub. Date: Apr. 26, 2012

(54) REAL-TIME POINT REDEMPTION IN A MERCHANT REDEMPTION NETWORK

(75) Inventors: Jacob Matthew Sterling, Creve Coeur, MO (US); Thad David Peterson, Marietta, GA (US)

(73) Assignee: MARITZ INC., Fenton, MO (US)

(21) Appl. No.: 12/909,007

(22) Filed: Oct. 21, 2010

(51) Int. Cl. G06Q 30/00

(52) U.S. Cl. 705/14.38

(57) ABSTRACT

The invention includes methods and systems for use with a redemption campaign of an issuer implemented via a real-time redemption network (“RRN”), with RRN being connected to a credit/debit transaction network, and implemented via a mobile message system for an account of a cardholder having a mobile device connected to the mobile messaging system. The cardholder receives marketing engagements of a redemption campaign via a cardholder mobile device based on an approved credit/debit card transaction and having a points account associated with the card.

### BACKGROUND

Conventionally, merchants or networks of merchants often participate in traditional loyalty rewards programs. These merchants and networks of merchants, e.g. Merchant Rewards Networks (MRN) as known in the art, act as earnings engines attached to the traditional loyalty rewards programs. The concept is that, by shopping at a merchant participating in a loyalty reward program, either individually or as a merchant in a MRN, the cardholder can earn points, cash back, and other benefits beyond simply shopping alone. However, several fundamental problems exist with the current loyalty rewards program model and the MRN model. First, the delay between purchasing and recognition of the additional earnings reduces the psychological benefit of the MRN program to the cardholder. Second, as MRN programs become commoditized, it is increasingly difficult to justify participating in them as they are less and less differentiated. Third, although an issuing bank may receive funds from the merchants to offset the cost of additional point earning, these funds cannot be recognized as revenue until a “breakage” event occurs, meaning the cardholder has somehow forfeited the points through lack of use. Since the funds cannot be considered revenue until this “breakage” occurs, there are also negative tax implications to accruing monies in a point liability account.

### SUMMARY

Embodiments of the invention include methods and system for use with a redemption campaign of an issuer implemented via a real-time redemption network (“RRN network”). In one embodiment, a method comprises receiving, by a RRN computing device connected to the RRN network via the RRN network from an authorization computing device, information identifying an authorized transaction at a point-of-sale, with the authorized transaction involving the account of the cardholder, the authorization computing device being associated with an issuer of the account of the cardholder, and the account of the cardholder having a points account associated therewith. The method further comprises determining, at the RRN computing device, whether the authorized transaction identified by the received information qualifies for a redemption campaign of the issuer of the card of the cardholder. In the event that the authorized transaction identified by the received information qualifies for the redemption campaign of the issuer of the card of the cardholder, the method comprises: sending, by the RRN computing device via the mobile messaging system to the mobile device, a message indicating a marketing engagement to the cardholder where the marketing engagement requests a response from the cardholder; receiving, by the RRN computing device via the mobile messaging system from the mobile device, a response accepting the marketing engagement presented to the cardholder; transmitting, by the RRN computing device via the RRN network to the points account of the cardholder, an adjustment to be applied to the points account based on the marketing engagement and the received response accepting the engagement; and transmitting, by the RRN computing device via the RRN network to the issuer of the card of the cardholder, an adjustment to the approved transaction amount based on the transmitted point adjustment.

In another embodiment, a computer-implemented comprises receiving, by a RRN computing device connected to the RRN network via the RRN network from an authorization computing device, information identifying an authorized transaction at a point-of-sale device, with the approved transaction involving the account of the cardholder, the authorization computing device being associated with an issuer of the account of the cardholder, and the account of the cardholder having a points account associated therewith. The method further comprises determining, at the RRN computing device, whether the authorized transaction identified by the received information qualifies for the redemption campaign of the issuer of the card of the cardholder. In the event that the authorized transaction identified by the received information qualifies for the redemption campaign of the issuer of the card of the cardholder and the point-of sale device is capable of displaying the redemption campaign of the issuer, transmitting, by the RRN computing device via a network to the point-of-sale device, the redemption campaign for presenting to the cardholder. In the event that the authorized transaction identified by the received information qualifies for the redemption campaign of the issuer of the card of the cardholder and the point-of-sale device is not capable of displaying the redemption campaign of the issuer, transmitting, by RRN computing device via a mobile messaging system to the mobile device, the redemption campaign for presenting to the cardholder.

In another embodiment, a computer-executed method comprises receiving, by a RRN computing device connected to RRN network via RRN network from an authorization computing device, information identifying an authorized transaction at a point-of-sale, with the authorized transaction involving the account of the cardholder, the authorization computing device being associated with an issuer of the account of the cardholder, and the account of the cardholder having a points account associated therewith. The method further comprises determining, at the RRN computing device, whether the authorized transaction identified by the received information qualifies for the redemption campaign of the issuer of the card of the cardholder. In the event that the authorized transaction identified by the received information qualifies for the redemption campaign of the issuer of the card of the cardholder, the method comprises: sending, by the RRN computing device via the mobile messaging system to the mobile device, a message indicating a marketing engagement to the cardholder wherein the marketing engagement requests a response from the cardholder; receiving, by the RRN computing device via the mobile messaging system from the mobile device, a response accepting the marketing engagement presented to the cardholder; transmitting, by the RRN computing device via RRN network to the issuer, an adjustment to be applied to the points account of the cardholder based on the marketing engagement and the received response accepting the engagement; and transmitting, by the RRN computing device via RRN network to the issuer of the card of the cardholder, the adjustment corresponding to the adjustment to the purchase price based on the transmitted point adjustment.

In another embodiment, a method comprises receiving, by a RRN computing device connected to RRN network via RRN network from an authorization computing device, information identifying an authorized transaction at a point-of-sale, with the approved transaction involving the account of the cardholder, the authorization computing device being associated with an issuer of the account of the cardholder, and the account of the cardholder having a points account associated therewith. The method further comprises determining, at the RRN computing device, whether the authorized transaction identified by the received information qualifies for the redemption campaign of the issuer of the card of the cardholder. In the event that the authorized transaction identified by the received information qualifies for the redemption campaign of the issuer of the card of the cardholder, the method comprises: sending, by the RRN computing device via the mobile messaging system to the mobile device, a message indicating a marketing engagement to the cardholder wherein the marketing engagement requests a response from the cardholder; receiving, by the RRN computing device via the mobile messaging system from the mobile device, a response accepting the marketing engagement presented to the cardholder; transmitting, by the RRN computing device via the RRN network to the points account of the cardholder, an adjustment to be applied to the points account of the cardholder based on the marketing engagement and the received response accepting the engagement, where the points account of the cardholder is maintained by the RRN computing device; and transmitting, by the RRN computing device via the RRN network to the issuer of the card of the cardholder, the adjustment corresponding to the adjustment to the purchase price based on the transmitted point adjustment. In another embodiment, a real-time redemption network system comprises a computer-readable storage medium having stored thereon records of points account information, where each record comprises a number associated with a card of the card holder, points account of the cardholder associated therewith, and a cardholder mobile device identifier. The system further comprises a data communication network interface for communicating with a mobile message delivery device and a data communication network interface for communicating with a campaign computing device storing a redemption campaign for an issuer. The system also comprises a data communication network interface for communicating with an authorization computing device of the issuer in a credit/debit transaction network, the authorization computing device authorizing credit/debit transactions at a point-of-sale, and a data communication network interface for communication with a computing device storing redemption program cardholder records, the records identifying cards of cardholders participating the redemption program of the issuer. The system additionally comprises a RRN network server. The server is configured to execute computer-executable instructions for receiving, via the authorization computing device data communication network interface, information identifying an authorized transaction at a point-of-sale, with the authorized transaction involving an account of a cardholder and the account of the cardholder having a points account associated therewith. The computer-executable instructions also comprise instructions for determining, at the RRN network server, whether the authorized transaction identified by the received information qualifies for the redemption campaign of the issuer stored on the campaign computing device. In the event that the authorized transaction identified by the received information qualifies for the redemption campaign stored on the campaign computing device, the computer-executable instructions additionally comprise instructions for: sending, by the RRN network server via the mobile message delivery device data communication network interface to the mobile device based on the cardholder mobile identifier associated with the points account, a message indicating a marketing engagement to the cardholder wherein the marketing engagement requests a response from the cardholder; receiving, by the RRN network server via the mobile message delivery device data communication network interface from the mobile device, a response accepting the marketing engagement presented to the cardholder; applying, by the RRN network server, an adjustment to the points account based on the marketing engagement and the received response accepting the engagement; and transmitting, by the RRN computing device via a data communication network to the issuer of the card of the cardholder, an adjustment to the approved transaction amount based on the transmitted point adjustment.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other objects and features will be in part apparent and in part pointed out hereinafter.

### BRIEF DESCRIPTION OF THE DRAWINGS

FIG. 1A is an exemplary database table for storing points account records for at least one card of a cardholder and a corresponding points account.

FIG. 1B is an exemplary database table for storing cardholder records.

FIG. 2 is a block diagram of a system according to the invention including a real time redemption network (RRN) for receiving information identifying authorized transactions and delivering marketing engagements of a redemption campaign to the cardholder.

FIG. 3 is an exemplary flow diagram for a method for receiving information identifying an authorized transaction at a POS and sending a marketing engagement of a redemption campaign to a mobile device of the cardholder for acceptance.

FIG. 4 is an exemplary flow diagram for receiving information identifying an authorized transaction at a POS and sending a marketing engagement of a redemption campaign to an acceptance device at the POS, where the acceptance device is capable of receiving marketing engagements, otherwise sending the marketing engagement to a mobile device of the cardholder for acceptance.

FIG. 5 is a diagram of an exemplary RRN domain and an exemplary payment network domain, where the points account information is maintained by an issuer of the card of a cardholder.

FIG. 6 is a diagram of an exemplary RRN domain and an exemplary payment network domain, where the points account information is maintained by a computing device in the RRN domain.

Corresponding reference characters indicate corresponding parts throughout the drawings.

### DESCRIPTION OF THE PREFERRED EMBODIMENTS

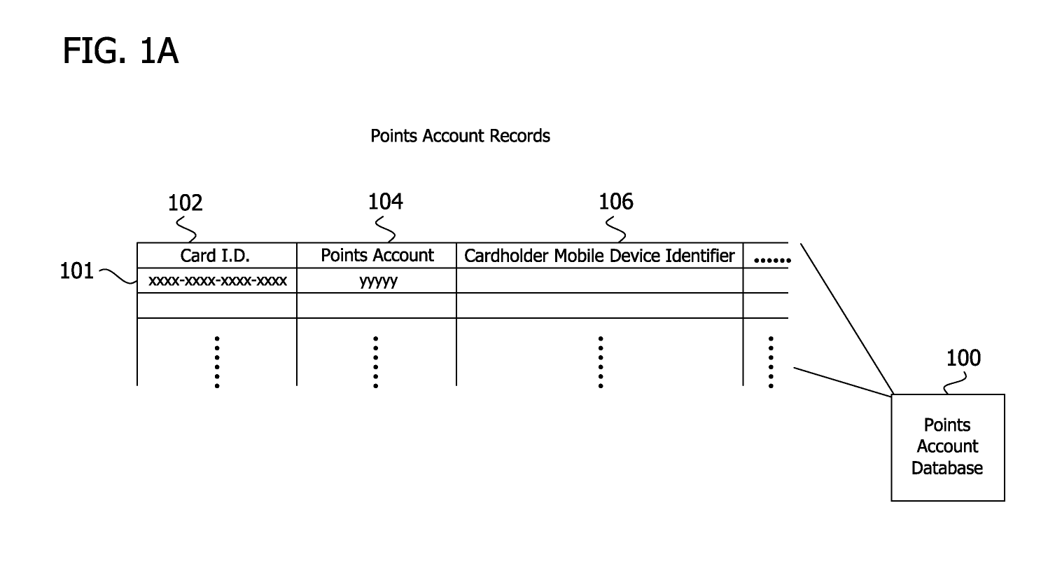

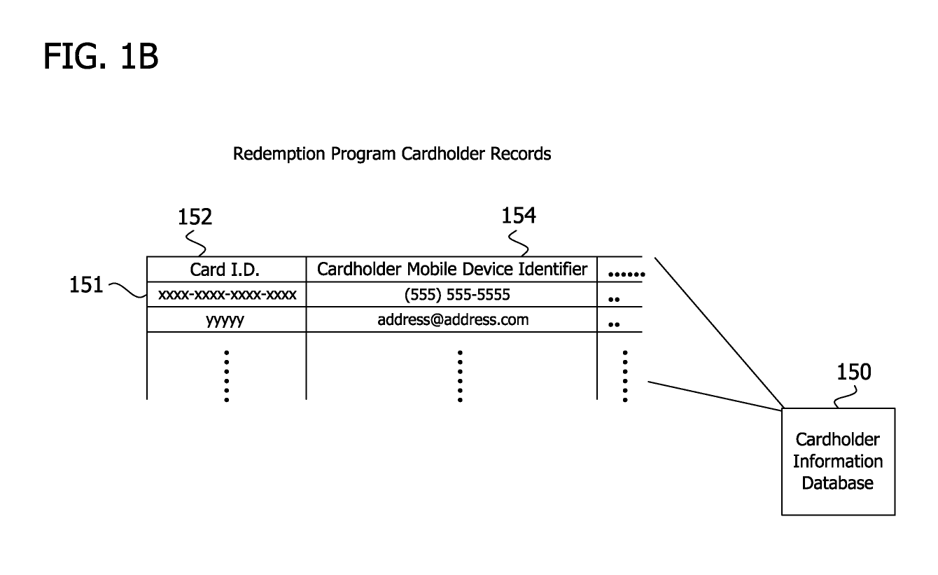

FIG. 1 illustrates an exemplary points account database 100 for storing points account records for cardholders enrolled in a rewards program of issuers of the cards. In general, a card issuer maintains a rewards program that benefits cardholders who are enrolled in the rewards program and utilize the card in subsequent purchases. In some embodiments, cardholders register for a program while in other embodiments the cardholder may be enrolled by the card issuer. After the cardholder is enrolled in a rewards program of the issuer, e.g., by registering via a website of the issuer, subsequent use of the card to make purchases generally earns the cardholder rewards, such as points, according to the terms of the program. Upon enrolling in the program, a points account record 101 is maintained for and associated with the card account of each cardholder. The points account record 101 comprises, among other things, entries for a card ID 102, a points account 104, and a cardholder mobile device 106. Rewards are delivered to participants in real time at the time of purchase at the point of sale. Rewards may be communicated via the cardholder's mobile device 106 or via a terminal at the point of sale. The card ID 102 is a unique identifier associated with a card issued to a cardholder by a card issuer.

It is contemplated that the RRN system may be configured to deliver points redemption opportunities across multiple protocols to mobile devices, including but not limited to: SMS (short message service) or other proprietary carrier services; WAP (wireless application protocol); and/or the Internet/Web (for example, a web site specifically designed for viewing by a mobile device.)

It is also contemplated that the RRN system may be configured to communicate with various form factors of a mobile device, including but not limited to: standard mobile phones, smart phones or Internet-enabled phones, with or without a touch screen; personal touchpad devices; and mobile devices embedded within larger form factors (for example a wireless ATM or kiosk.)

It is also contemplated that the RRN system may be configured to implement any type of point based program, such as a uniform point conversion rate or a tailored point conversion rate calculated by one or more of the following: participant/customer profile and preferences; merchant location; original transaction currency; merchant/participant level of participation in the program; items purchased; type of mobile device involved; and type of original payment instrument used.

In one embodiment, the card ID 102 is the card number imprinted into the card. For example, the card ID 102 is an industry standard sixteen-digit account number in the format “XXXX XXXX XXXX XXXX”. In other embodiments, the card ID is any number that uniquely identifies the card, such as an RFID tag, etc. Regardless of the format of the card ID 102, each card ID 102 has a points account 104 associated therewith. In an embodiment, the points account 104 represents a total quantity of points for the card of the card holder identified by the card ID 102. For example, the points account database 100 may indicate that a particular points account 104 associated with a particular card ID 102 has a balance of 10,000 points. The cardholder mobile device identifier 106 comprises an identifier that, when used with a mobile messaging system, permits data to be transmitted to a mobile device associated with the card of the cardholder. For example, a phone number or an email address associated with a cardholder mobile device permits data to be transmitted to the mobile device.

FIG. 1B illustrates an exemplary cardholder information database 150 for storing redemption program cardholder records. A cardholder record 151 comprises, among other things, card ID 152 of a cardholder enrolled in a program of an issuer. In an embodiment, the card ID 152 corresponds to the card ID 102 in the points account database 100. In another embodiment, information stored in the cardholder information database provides a correlation between the redemption program cardholder records and the points account records. Optionally, the cardholder record 151 also comprises a cardholder mobile device identifier 154. Like cardholder mobile device identifier 106, identifier 154 comprises an identifier that, when used with a mobile messaging system, permits data to be transmitted to a mobile device associated with the card of the cardholder. For example, a phone number or an email address associated with a cardholder mobile device permits data to be transmitted to the mobile device.

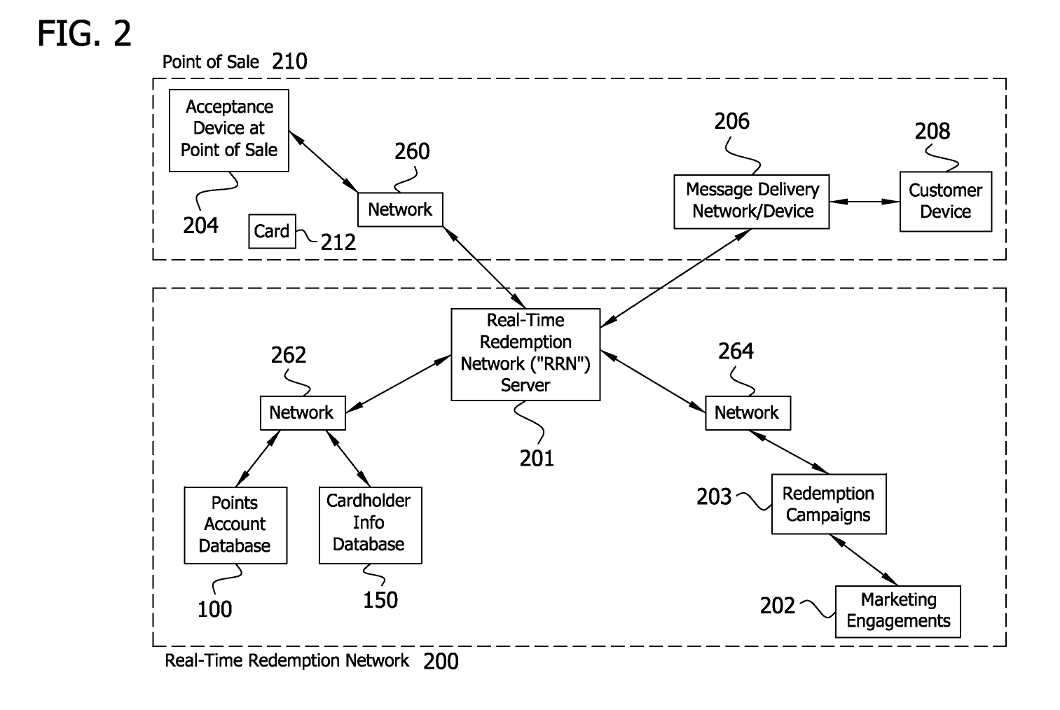

FIG. 2 is a diagram of a Real-time Redemption Network (“RRN”) 200 including an exemplary RRN server 201 for receiving information identifying authorized transactions and delivering a marketing engagement 202 of a redemption campaign 203 to cardholders at a point-of-sale (“POS”) 210. In one embodiment, the marketing engagement 202 of the redemption campaign 203 permits a cardholder to convert a transaction, or a portion thereof, into points in real-time at the time of sale based on the marketing engagements. In other embodiments, the marketing engagement 202 of the redemption campaign 203 is directed to non-redemption activities, such as but not limited to, future discounts. Prior to the time of sale, an issuer creates, modifies, or otherwise maintains redemption campaigns 202 for presentation to cardholders. When a cardholder presents a card 212 at the POS acceptance device 204 to pay for a pending transaction, the acceptance device transmits details of the pending transaction and details of the present card to an authorization switch (not shown) via network 260 for authorization by the card issuer. The pending transaction is either authorized by the issuer or declined by the issuer, based on factors such as available credit or fraud indicators. When the pending transaction is authorized by the issuer, the authorized transaction is received at the RRN server 201 via the network 260. The RRN server 201 utilizes the received authorized transaction and information from the redemption program cardholder information database 150 to determine if the card of the cardholder is enrolled in a redemption program. If so, the server 201 further utilizes information from the points account database 100 and the cardholder information database 150, accessible via network 262, along with the redemption campaigns 203, accessible via network 264, to determine which marketing engagements 202 to present to the cardholder either. The presentation occurs on a mobile device 208 of the cardholder, on the acceptance device 204 at the POS, or both. In an embodiment, the message delivery network/device comprises at least a SMS delivery network/device or an MMS delivery network/device. While networks 260, 262 and 264 are illustrated separately, networks 260, 262 and 264 may comprise a single network, multiple networks, or some combination thereof. Various embodiments of the RRN server 201 as described below.

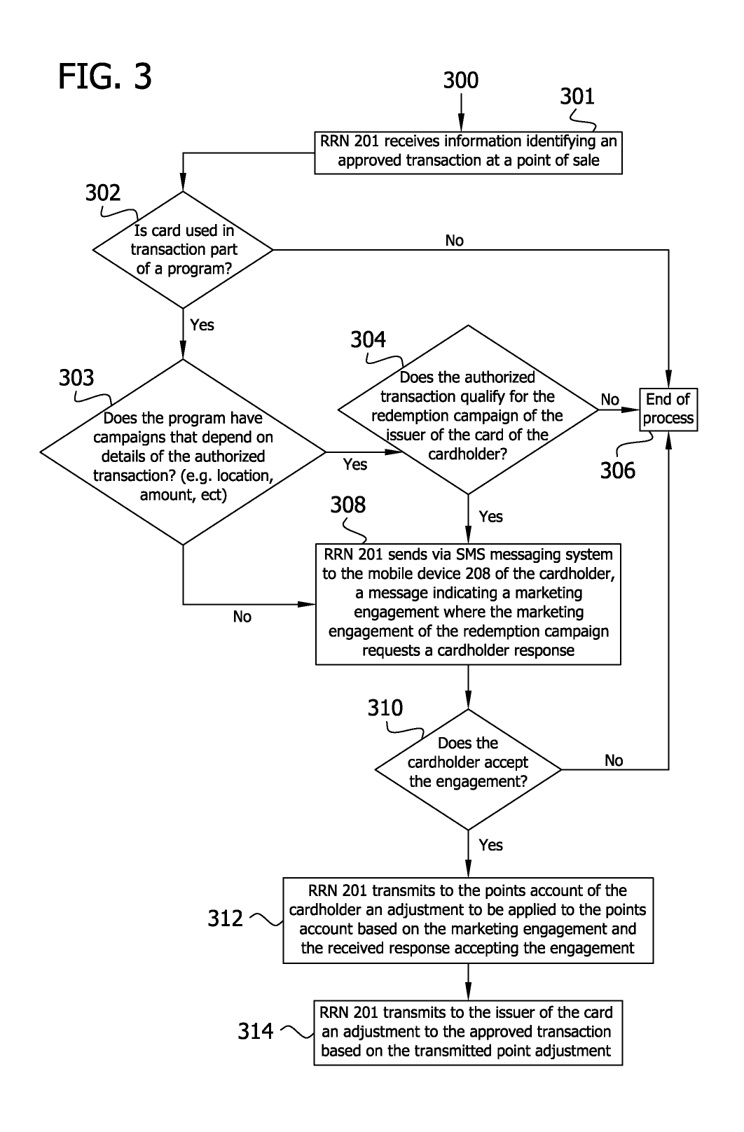

In FIG. 3, an exemplary flow diagram describes a process illustrating one embodiment of the RRN server 201. At 300, an authorization switch transmits an authorized transaction to the RRN server 201, as described above. At 301, the RRN server 201 receives information identifying an authorized transaction at a POS. The authorized transaction comprises, among other things, a transaction amount and information identifying the card of the cardholder used to pay for the transaction. In other embodiments, the information further comprises a list of items included in the transaction and the purchase price of each item in the list. Based on the received information, RRN server 201 determines, at 302, if the card 212 used for the transaction is part of a redemption program based on the information in the cardholder information database 150. If the card is not part of a redemption program, the process terminates at 306, indicating that none of the marketing engagements 202 should be presented to the cardholder. If the card is part of a redemption program, the RRN server 202 determines, at 303, if the redemption program has an associated redemption campaign 203 that depends upon details of the authorized transaction, e.g., location of purchase, transaction amount etc. If not, the process continues at 308, as described below. Otherwise, the process proceeds to 304. At 304, the RRN server 201 determines if the authorized transaction qualifies for the redemption campaign 203 of the issuer of the card 212 by, among other methods, comparing elements of the redemption campaign 203 with elements of the authorized transaction. These elements may include, but are not limited to, a merchant category code, transaction amount, merchant ID, geography, specific items or types of items purchased, information regarding the cardholder, and/or information regarding the points account associated with the card of the cardholder. Thus, in one embodiment, the process determines at 304 whether the cardholder of the authorized transaction identified by the received information qualifies for a redemption campaign of the issuer of the card of the cardholder. In another embodiment, the process at 304 determines whether an element of the authorized transaction identified by the received information qualifies for a redemption campaign of the issuer of the card of the cardholder. If the RRN server 201 determines that the authorized transaction does not qualify for the redemption campaign 203, the process terminates at 306. Otherwise, the RRN server 201 determines that the authorized transaction is a qualified transaction and the process continues at 308.

At 308, the RRN server 201 sends a message indicating a marketing engagement 202 of the redemption campaign. The RRN server 201 sends the message to a mobile device 208 via a mobile message system 206 using the cardholder device identifier 106. The marketing engagement 202 indicated in the message sent at 308 requests a cardholder response.

By way of example and not limitation, a marketing engagement requests a response by inquiring “Do you want to use XXX points to pay $XXX of the transaction today, please respond with “YES”, otherwise respond with “NO”. On the other hand, a marketing engagement not requesting a response would state “Your purchase of $XXX today qualifies you to receive XXX at your next purchase within the next ?? days”. If the engagement requires cardholder acceptance at 310 and the cardholder does not accept the engagement, the process terminates at 306. Otherwise, the process continues to 312.

At 312, the RRN server 201 transmits to the points account of the cardholder, via network 262, an adjustment to be applied to the points account associated with the card of the cardholder based on the marketing engagement and the received response from the cardholder accepting the engagement. The adjustment comprises a credit adjustment for increasing the total points in the points account, or alternatively, the adjustment comprises a debit adjustment for decreasing the total points in the points account. At 314, the RRN server 201 transmits, to the issuer of the card, an adjustment to the approved transaction based on the transmitted point adjustment. While conventional cardholder points redemption system transmits an adjustment to a transaction amount, requiring merchant participation in the redemption system, the merchant in the process illustrated in FIG. 3 remains unaware of any adjustments, as any adjustment to the transaction amount is made by the card issuer to the cardholder account for the card. An example illustrating this distinction is explained below.

In an embodiment, the marketing engagement indicates satisfying at least a portion of the transaction amount by using points in the points account associated with the card of the cardholder to pay for the portion of the transaction amount. When the cardholder uses points to pay, the RRN server 201 utilizes an adjustable conversion ratio to convert the points the cardholder desires to use. The adjustable conversion ratio defines the ratio of points to currency at the time of conversion, e.g., when the cardholder accepts the marketing engagement at the POS. By adjusting the conversion rate, the rate can include a convenience premium. The convenience premium comprises a number of points “charged” to convert points in the points account that does not satisfy the transaction amount.

By way of example and not limitation, a marketing engagement 202 presented to the cardholder via the cardholder mobile device indicates to the cardholder “You can use 11,000 points for your $100 purchase today” and optionally includes “(100 point=$1 plus an additional 10 points per $1 as a convenience premium)”. In other words, the cardholder agrees to give up, or forfeit, a given number of points in order to use for a portion of the transaction amount using points in the points account associated with the card. From an accounting/tax perspective, this advantageously results in “breakage”, as previously discussed, allowing the issuing bank to recognize funds corresponding to the “breakage” amount as revenue.

By way of example and not limitation, consider a typical financial example of a $100 transaction assessed at 1.8% interchange (an amount charged to the merchant for the transaction), in a conventional system where the participating merchant contributes 1% of the transaction as points. In the convention system, the following occurs: $1.80 in interchange, of which $1.00 in point liability accrues and cannot be counted as revenue until breakage; $1.00 in merchant contribution, which accrues as additional points liability and cannot be counted as revenue until breakage; Resulting net: $0.80 in recognized revenue. An example of the same transaction, according to embodiments of the present invention, redeemed for points at a favorable rate, e.g., 110 points per $1, instead of 100 points per $1, with 10 points per $1 as a convenience premium: $1.80 in interchange, none of which accrues as points liability; the cardholder exchanges $110 in accrued point value (11,000 points) to pay $98.20 in merchant payables ($100-$1.80 interchange fee), resulting in $11.80 in de facto breakage; $1.00 in merchant contribution, none of which accrues as points liability; Resulting net: $14.60 in recognized revenue.

It should also be noted that, since the RRN server 201 transmits to the points account 100 a points adjustment at 312 to satisfy some or the entire transaction amount, and an adjustment to the issuer to the approved transaction, embodiments of the present invention mitigate the risk of the cardholder defaulting on the transaction. In effect, the points act as a secured deposit that the cardholder uses to pay for the transaction.

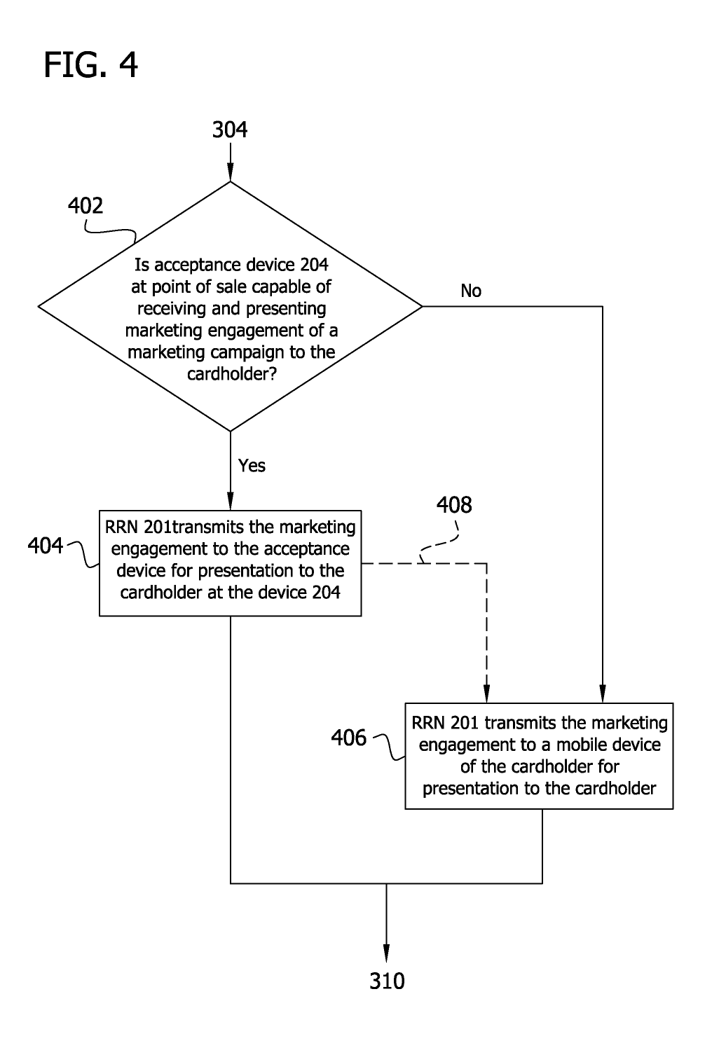

FIG. 4 describes another embodiment of the RRN server 201, wherein the RRN server 201 alternatively sends the marketing engagement 202 of the redemption campaign 201 to the acceptance device 204 at the POS 210. After step 304, the RRN server 201 determines, at 402, if the acceptance device 204 at the POS 210 is capable of receiving and presenting the marketing engagement 202 of the redemption campaign 203 to the cardholder. If the acceptance device 204 is capable of presenting the marketing engagement 202, the RRN server 201 transmits at 404 the marketing engagement 202 to the acceptance device 204 via network 260 for presentation to the cardholder on the acceptance device 204 at the POS 210. In an embodiment, the RRN server 201 receives information regarding the capabilities of the acceptance device 204 from the acceptance device 204 in order to make the determination. In other embodiments, the RRN server 201 maintains, accesses, or otherwise acquires information regarding acceptance devices, including acceptance device 204. If the acceptance device 204 is not capable of presenting the marketing engagement 202, the RRN server 201 transmits at 406 the marketing engagement 202 to the mobile device 208 of the cardholder via the message delivery network/device 206. In one optional embodiment, it is also contemplated that, if the acceptance device 204 is capable of presenting the marketing engagement 202, the RRN server 201 transmits at 404 the marketing engagement 202 to both the acceptance device 204 and the mobile device, as indicated by dashed line 408. The process in FIG. 4 then resumes processing as shown at 310 in FIG. 3.

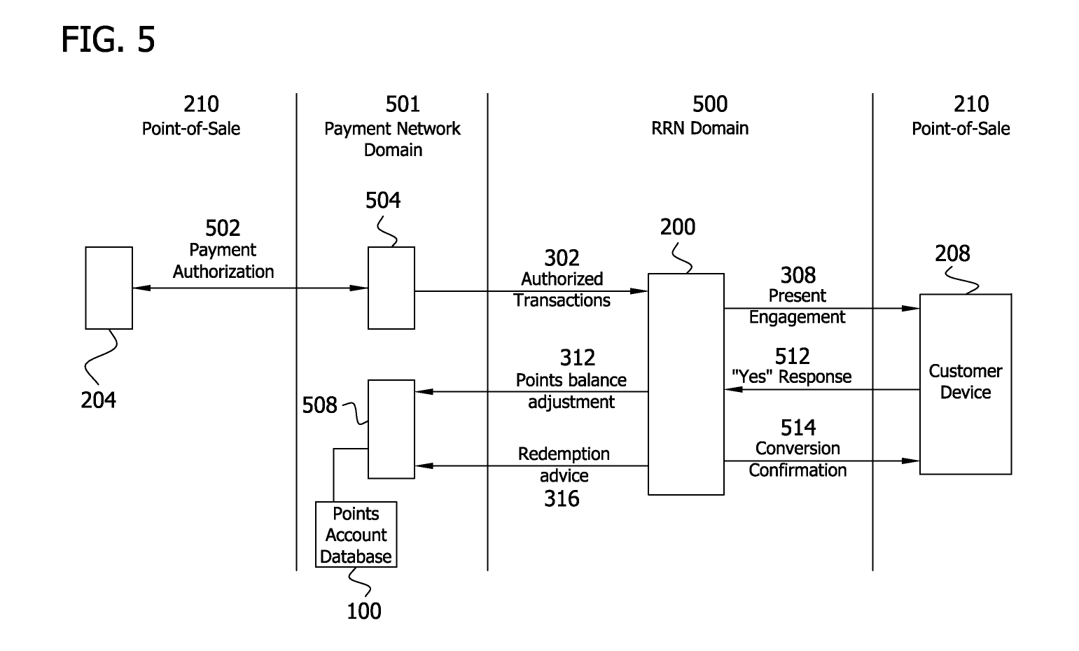

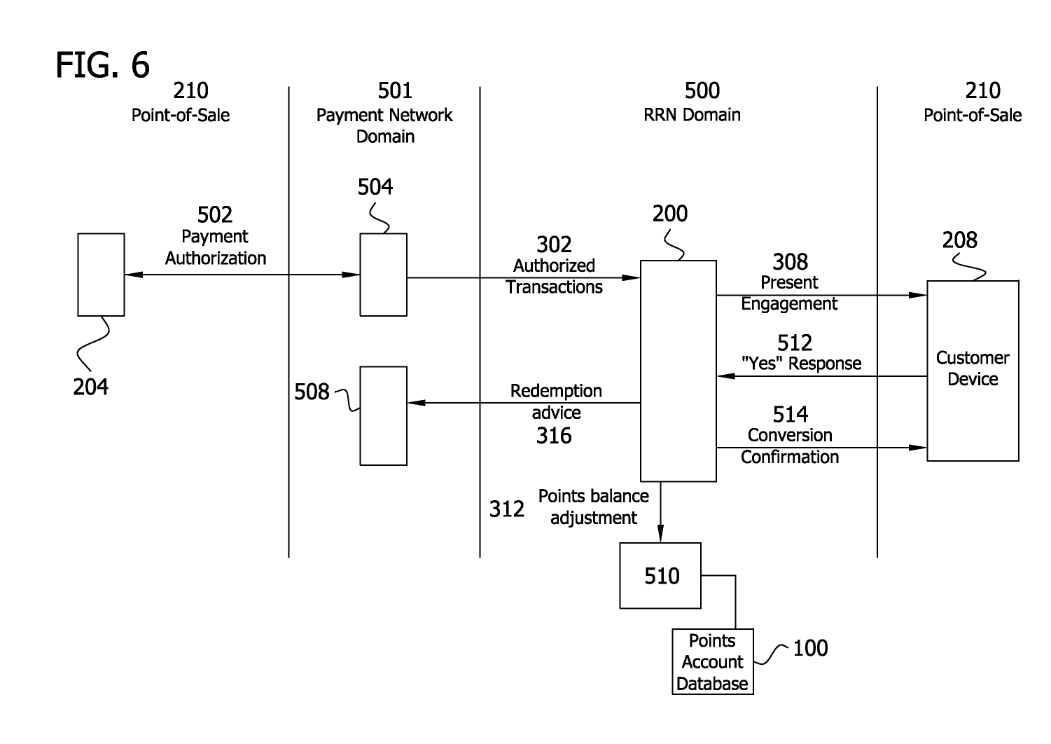

FIGS. 5 and 6 are diagrams of the interactions of the point-of-sale 210 with an exemplary RRN domain 500 and with an exemplary payment domain 501. In FIG. 5, the points account database 100 is maintained by computing device 508 in the payment domain, separate from the RNN server 201 in RRN domain 500. The process of using a redemption campaign of an issuer implemented via the RRN server 201 proceeds substantially according to the process shown in FIGS. 3 and 4. For example, at 302, the RRN server 201 receives information from authorization device 504 identifying an authorized transaction as described in FIGS. 3 and 4. At 308, the RRN server 201 sends a message indicating the marketing engagement 202 of the redemption campaign 201 to the mobile device 208 via the mobile message system 206 using the cardholder device identifier 106. Alternatively, the RRN server 201 may send the message to the acceptance device 204 at the POS 210 as illustrated in FIG. 4, but not shown in FIG. 5. The marketing engagement 202 indicated in the message sent at 308 requests a cardholder response. At 512, the RRN server 201 receives the cardholder response. In one embodiment, the RRN server 201 sends a conversion confirmation message 514 to the cardholder confirming the cardholder's request to convert points. In FIG. 5, the RRN server 201 transmits, at 312, the adjustment to the points account of the cardholder to the computing device 508 in the payment network domain 501, separate from the RRN server 201 and the RRN domain 500. In FIG. 6, the RRN server 201 transmits, at 312, the adjustment to the points accounts database, where the points account database is maintained by computing device 510 in the RRN domain 500. In an embodiment, the RRN server 201 and computing device 510 are separate computing devices. In another embodiment, the RRN server 201 and computing device 510 comprise the same computing device.

In an embodiment, the RRN server 201 determines whether the approved transaction identified by the received transaction information qualifies for a redemption campaign. If the transaction qualifies, the server 201 also determines whether the received transaction information qualifies for a plurality of redemption campaigns. The RRN server 201 then transmits a plurality of marketing engagements, based on the rules of the program to the cardholder, as illustrated in FIGS. 3-6. In one example, the RRN server 201 may transmit all potential offers to the cardholder for selection based on program rules. In another example, the RRN server 201 transmits a pre-filtered subset of all offers based on program rules and/or based on established preferences and previous cardholder behavior.

In an embodiment, the points account 104 is a reference identifier to another record stored in the points account database 100 or stored independently of the points account database 100. In this embodiment, the referenced record stores the quantity of points in the points account 104.

In another embodiment, the cardholder device identifier 154 is a reference identifier to another record stored in the cardholder information database 150 or stored independently of the cardholder information database 150. In this embodiment, the referenced record stores the information necessary for sending data to a mobile device of the cardholder.

In an embodiment, a computer-readable storage medium stores records of the cardholder information database 150, a computer-readable storage medium storing records of the points account database 100, and a computer-readable storage medium stores redemption campaigns 202 associated with the issuers, said computer-readable storage medium further storing marketing engagements 202 associated with the stored redemption campaigns 202.

In an embodiment, a computer-readable storage medium stores computer-executable instructions for executing the steps demonstrated in FIG. 3, a computer-readable storage medium stores computer-executable instructions for executing the steps demonstrated in FIG. 4, a computer-readable storage medium stores computer-executable instructions for executing the steps demonstrated in FIG. 5, and a computer-readable storage medium stores computer-executable instructions for executing the steps demonstrated in FIG. 6.

In an embodiment, the RRN server 201 includes a software interface and/or a hardware interface for communicating with the authorization computing device of the issuer (not shown) via network 260. The RRN server 201 may further include a software interface and/or a hardware interface for communicating with the message delivery network/device 206. The RRN server 201 may also include a software interface and/or a hardware interface for communicating with the campaign computing device storing the redemption campaigns 203. The RRN server 201 may additionally include a software interface and/or a hardware interface for communicating with computing device storing redemption program cardholder records 150. The interfaces utilize any communication protocol(s) that facilitate or otherwise permit the described communication.

Computer readable media, which include both volatile and nonvolatile media, removable and non-removable media, may be any available medium that may be accessed by computer 600. By way of example and not limitation, computer readable media comprise computer storage media and communication media. Computer storage media include volatile and nonvolatile, removable and non-removable non-transitory media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by a computing device. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The RRN server 201 may also include other removable/non-removable, volatile/nonvolatile computer storage media. The drives or other mass storage devices and their associated computer storage media provide storage of computer readable instructions, data structures, program modules and other data for the RRN server 201. While the RRN server 201 is illustrated throughout as a single computing device, it should be understood that the RRN server 201 may comprise either a single computing device or a collection of computing devices, said collection of computing devices interconnect by way of a wired communication network, a wireless communication network, or some combination thereof.

Generally, the data processors of the RRN server 201 are programmed by means of instructions stored at different times in the various computer-readable storage media of the computer. At execution, they are loaded at least partially into the computer's primary electronic memory.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including the RRN server 201 and devices 204, 208, 504, 508, and 510, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, the devices referenced above execute computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A computer-executed method for use with a redemption campaign of an issuer implemented via a real-time redemption network (“RRN network”), said RRN network being connected to a credit/debit transaction network, and implemented via a mobile messaging system for an account of a cardholder having a mobile device connected to the mobile messaging system, said method comprising:
receiving, by a RRN computing device connected to the RRN network via the RRN network from an authorization computing device, information identifying an authorized transaction at a point-of-sale, said authorized transaction involving the account of the cardholder, said authorization computing device being associated with an issuer of the account of the cardholder, said account of the cardholder having a points account associated therewith;
determining, at the RRN computing device, whether the authorized transaction identified by the received information qualifies for a redemption campaign of the issuer of the card of the cardholder; and
in the event that the authorized transaction identified by the received information qualifies for the redemption campaign of the issuer of the card of the cardholder, then:
sending, by the RRN computing device via the mobile messaging system to the mobile device, a message indicating a marketing engagement to the cardholder wherein the marketing engagement requests a response from the cardholder;
receiving, by the RRN computing device via the mobile messaging system from the mobile device, a response accepting the marketing engagement presented to the cardholder;
transmitting, by the RRN computing device via the RRN network to the points account of the cardholder, an adjustment to be applied to the points account based on the marketing engagement and the received response accepting the engagement; and
transmitting, by the RRN computing device via the RRN network to the issuer of the card of the cardholder, an adjustment to the approved transaction amount based on the transmitted point adjustment.

2. The method of claim 1, wherein the marketing engagements indicate satisfying at least a portion of the transaction amount by converting points in the points account associated with the card of the cardholder, wherein the conversion of points is based on an adjustable conversion ratio defining the ratio of points to currency at the time of conversion, said conversion rate being adjustable to include a convenience premium, wherein the converted points are decremented from the points account associated with the card of the cardholder without a corresponding offset to the transaction amount for the convenience premium.

3. The method of claim 1, wherein presenting the marketing engagements includes transmitting a plurality of marketing engagements to a device of the cardholder.

4. The method of claim 1, wherein the authorized transaction qualifies for a plurality of redemption campaigns of the issuer of the card of the cardholder.

5. The method of claim 1, wherein the mobile messaging system comprises at least one of a SMS messaging system, a MMS messaging system, a WAP messaging system, and a messaging system based on other mobile communication protocols.

6. The method of claim 1, said method further comprising:
a computer-readable storage medium storing records of cardholder information, wherein each record comprises a number associated with a card of the card holder and a cardholder device identifier associated therewith;
a computer-readable storage medium storing records of points account information, wherein each record comprises a number associated with a card of the card holder and a points account of the cardholder associated therewith;
a computer-readable storage medium storing redemption campaigns associated with the issuers, said computer-readable storage medium further storing marketing engagements associated with the stored redemption campaigns; and
a computer-readable storage medium storing computer-executable instructions for execute the steps of claim 1.

7. The method of claim 1 wherein said determining comprises at least one of: determining whether the cardholder of the authorized transaction identified by the received information qualifies for a redemption campaign of the issuer of the card of the cardholder, and determining whether an element of the authorized transaction identified by the received information qualifies for a redemption campaign of the issuer of the card of the cardholder.

8. A computer-executed method for use with a redemption campaign of an issuer implemented via a real-time redemption network (“RRN network”), said RRN being connected to a credit/debit transaction network, and implemented via a mobile messaging system for an account of a cardholder having a mobile device connected to the mobile messaging system, said method comprising:
receiving, by a RRN computing device connected to the RRN network via the RRN network from an authorization computing device, information identifying an authorized transaction at a point-of-sale device, said approved transaction involving the account of the cardholder, said authorization computing device being associated with an issuer of the account of the cardholder, said account of the cardholder having a points account associated therewith;
determining, at the RRN computing device, whether the authorized transaction identified by the received information qualifies for the redemption campaign of the issuer of the card of the cardholder; and
in the event that the authorized transaction identified by the received information qualifies for the redemption campaign of the issuer of the card of the cardholder, then:
when the point-of sale device is capable of displaying the redemption campaign of the issuer, transmitting, by the RRN computing device via a network to the point-of-sale device, the redemption campaign for presenting to the cardholder; and
when the point-of-sale device is not capable of displaying the redemption campaign of the issuer, transmitting, by RRN computing device via a mobile messaging system to the mobile device, the redemption campaign for presenting to the cardholder.

9. The method of claim 8, wherein transmitting further comprises transmitting a message indicating a marketing engagement of the redemption campaign to the cardholder, wherein the marketing engagement requests a response from the cardholder.

10. The method of claim 8, wherein when the point-of sale device is capable of displaying the redemption campaign of the issuer, the method further comprises:
receiving, by the RRN computing device via the mobile messaging system from the point-of-sale device, a response accepting the marketing engagement presented to the cardholder;
transmitting, by the RRN computing device via the RRN network to the issuer, an adjustment to be applied to the points account of the cardholder based on the marketing engagement and the received response accepting the engagement; and
transmitting, by RRN computing device via the RRN network to the issuer of the card of the cardholder, said adjustment corresponding to the adjustment to the purchase price based on the transmitted point adjustment.

11. The method of claim 8, wherein the marketing engagements indicate satisfying at least a portion of the transaction amount by converting points in the points account associated with the card of the cardholder, wherein the conversion of points is based on an adjustable conversion ratio defining the ratio of points to currency at the time of conversion, said conversion rate being adjustable to include a convenience premium, wherein the converted points are decremented from the points account associated with the card of the cardholder without a corresponding offset to the transaction amount.

12. The method of claim 8, wherein presenting the one or more marketing engagements includes transmitting, by the RRN computing device, a plurality of marketing engagements to the device of the cardholder.

13. The method of claim 8, wherein the authorized transaction qualifies for a plurality of redemption campaigns of the issuer of the card of the cardholder.

14. The method of claim 8, wherein the mobile messaging system comprises at least one of a SMS messaging system, a MMS messaging system, a WAP messaging system, and a messaging system based on other mobile communication protocols.

15. The method of claim 8, said method further comprising:
a computer-readable storage medium storing records of cardholder information, wherein each record comprises a number associated with a card of the card holder and a cardholder device identifier associated therewith;
a computer-readable storage medium storing records of points account information, wherein each record comprises a number associated with a card of the card holder and a points account of the cardholder associated therewith;
a computer-readable storage medium storing redemption campaigns associated with the issuers, said computer-readable storage medium further storing marketing engagements associated with the stored redemption campaigns; and
a computer-readable storage medium storing computer-executable instructions for execute the steps of claim 8.

16. The method of claim 8 wherein said determining comprises at least one of: determining whether the cardholder of the authorized transaction identified by the received information qualifies for a redemption campaign of the issuer of the card of the cardholder, and determining whether an element of the authorized transaction identified by the received information qualifies for a redemption campaign of the issuer of the card of the cardholder.

17. A computer-executed method for use with a redemption campaign of an issuer implemented via a real-time redemption network (“RRN network”), said RRN being connected to a credit/debit transaction network, and implemented via a mobile messaging system for an account of a cardholder having a mobile device connected to the mobile messaging system, said method comprising:
receiving, by a RRN computing device connected to RRN network via RRN network from an authorization computing device, information identifying an authorized transaction at a point-of-sale, said authorized transaction involving the account of the cardholder, said authorization computing device being associated with an issuer of the account of the cardholder, said account of the cardholder having a points account associated therewith;
determining, at the RRN computing device, whether the authorized transaction identified by the received information qualifies for the redemption campaign of the issuer of the card of the cardholder; and
in the event that the authorized transaction identified by the received information qualifies for the redemption campaign of the issuer of the card of the cardholder, then:
sending, by the RRN computing device via the mobile messaging system to the mobile device, a message indicating a marketing engagement to the cardholder wherein the marketing engagement requests a response from the cardholder;
receiving, by the RRN computing device via the mobile messaging system from the mobile device, a response accepting the marketing engagement presented to the cardholder;
transmitting, by the RRN computing device via RRN network to the issuer, an adjustment to be applied to the points account of the cardholder based on the marketing engagement and the received response accepting the engagement; and
transmitting, by the RRN computing device via RRN network to the issuer of the card of the cardholder, said adjustment corresponding to the adjustment to the purchase price based on the transmitted point adjustment.

18. The method of claim 17, wherein the marketing engagements indicate satisfying at least a portion of the transaction amount by converting points in the points account associated with the card of the cardholder, wherein the conversion of points is based on an adjustable conversion ratio defining the ratio of points to currency at the time of conversion, said conversion rate being adjustable to include a convenience premium, wherein the converted points are decremented from the points account associated with the card of the cardholder without a corresponding offset to the transaction amount.

19. The method of claim 17, wherein presenting the marketing engagements includes transmitting a plurality of marketing engagements to the device of the cardholder.

20. The method of claim 17, wherein the authorized transaction qualifies for a plurality of redemption campaigns of the issuer of the card of the cardholder.

21. The method of claim 17, said method further comprising:
a computer-readable storage medium storing records of cardholder information, wherein each record comprises a number associated with a card of the card holder and a cardholder device identifier associated therewith;
a computer-readable storage medium storing records of points account information, wherein each record comprises a number associated with a card of the card holder and a points account of the cardholder associated therewith;
a computer-readable storage medium storing redemption campaigns associated with the issuers, said computer-readable storage medium further storing marketing engagements associated with the stored redemption campaigns; and
a computer-readable storage medium storing computer-executable instructions for execute the steps of claim 17.

22. The method of claim 17 wherein said determining comprises at least one of: determining whether the cardholder of the authorized transaction identified by the received information qualifies for a redemption campaign of the issuer of the card of the cardholder, and determining whether an element of the authorized transaction identified by the received information qualifies for a redemption campaign of the issuer of the card of the cardholder.

23. A computer-executed method for use with a redemption campaign of an issuer implemented via a real-time redemption network (“RRN network”), said RRN being connected to a credit/debit transaction network, and implemented via a mobile messaging system for an account of a cardholder having a mobile device connected to the mobile messaging system, said method comprising:
receiving, by a RRN computing device connected to RRN network via RRN network from an authorization computing device, information identifying an authorized transaction at a point-of-sale, said approved transaction involving the account of the cardholder, said authorization computing device being associated with an issuer of the account of the cardholder, said account of the cardholder having a points account associated therewith;
determining, at the RRN computing device, whether the authorized transaction identified by the received information qualifies for the redemption campaign of the issuer of the card of the cardholder; and
in the event that the authorized transaction identified by the received information qualifies for the redemption campaign of the issuer of the card of the cardholder, then:
sending, by the RRN computing device via the mobile messaging system to the mobile device, a message indicating a marketing engagement to the cardholder wherein the marketing engagement requests a response from the cardholder;
receiving, by the RRN computing device via the mobile messaging system from the mobile device, a response accepting the marketing engagement presented to the cardholder;
transmitting, by the RRN computing device via the RRN network to the points account of the cardholder, an adjustment to be applied to the points account of the cardholder based on the marketing engagement and the received response accepting the engagement, wherein the points account of the cardholder is maintained by the RRN computing device; and
transmitting, by the RRN computing device via the RRN network to the issuer of the card of the cardholder, said adjustment corresponding to the adjustment to the purchase price based on the transmitted point adjustment.

24. The method of claim 23, said method further comprising:
a computer-readable storage medium storing records of cardholder information, wherein each record comprises a number associated with a card of the card holder and a cardholder device identifier associated therewith;
a computer-readable storage medium storing records of points account information, wherein each record comprises a number associated with a card of the card holder and a points account of the cardholder associated therewith;
a computer-readable storage medium storing redemption campaigns associated with the issuers, said computer-readable storage medium further storing marketing engagements associated with the stored redemption campaigns; and
a computer-readable storage medium storing computer-executable instructions for execute the steps of claim 23.

25. The method of claim 23 wherein said determining comprises at least one of: determining whether the cardholder of the authorized transaction identified by the received information qualifies for a redemption campaign of the issuer of the card of the cardholder, and determining whether an element of the authorized transaction identified by the received information qualifies for a redemption campaign of the issuer of the card of the cardholder.

26. A real-time redemption network (“RRN network”) system comprising:
a computer-readable storage medium having stored thereon records of points account information, wherein each record comprises a number associated with a card of the card holder, points account of the cardholder associated therewith, and a cardholder mobile device identifier;
a data communication network interface for communicating with a mobile message delivery device;
a data communication network interface for communicating with a campaign computing device storing a redemption campaign for an issuer;
a data communication network interface for communicating with an authorization computing device of the issuer in a credit/debit transaction network, said authorization computing device authorizing credit/debit transactions at a point-of-sale;
a data communication network interface for communication with a computing device storing redemption program cardholder records, said records identifying cards of cardholders participating the redemption program of the issuer; and
a RRN network server, said server configured to execute computer-executable instructions for:
receiving, via the authorization computing device data communication network interface, information identifying an authorized transaction at a point-of-sale, said authorized transaction involving an account of a cardholder, said account of the cardholder having a points account associated therewith;
determining, at the RRN network server, whether the authorized transaction identified by the received information qualifies for the redemption campaign of the issuer stored on the campaign computing device; and
in the event that the authorized transaction identified by the received information qualifies for the redemption campaign stored on the campaign computing device, then:
sending, by the RRN network server via the mobile message delivery device data communication network interface to the mobile device based on the cardholder mobile identifier associated with the points account, a message indicating a marketing engagement to the cardholder wherein the marketing engagement requests a response from the cardholder;
receiving, by the RRN network server via the mobile message delivery device data communication network interface from the mobile device, a response accepting the marketing engagement presented to the cardholder;
applying, by the RRN network server, an adjustment to the points account based on the marketing engagement and the received response accepting the engagement; and
transmitting, by the RRN computing device via a data communication network to the issuer of the card of the cardholder, an adjustment to the approved transaction amount based on the transmitted point adjustment.

27. The system of claim 26, wherein the marketing engagements indicate satisfying at least a portion of the transaction amount by converting points in the points account associated with the card of the cardholder, wherein the conversion of points is based on an adjustable conversion ratio defining the ratio of points to currency at the time of conversion, said conversion rate being adjustable to include a convenience premium, wherein the converted points are decremented from the points account associated with the card of the cardholder without a corresponding offset to the transaction amount for the convenience premium.
